(19) United States
(12) Patent Application Publication
(10) Pub. No.: US 2023/0410676 A1
(43) Pub. Date: Dec. 21, 2023

(54) INFORMATION PROCESSING SYSTEM, ELECTRONIC MUSICAL INSTRUMENT, INFORMATION PROCESSING METHOD, AND MACHINE LEARNING SYSTEM

(71) Applicant: YAMAHA CORPORATION, Hamamatsu-shi (JP)

(72) Inventors: Akira MAEZAWA, Hamamatsu-shi (JP); Yuya TAKENAKA, Hamamatsu-shi (JP); Naoki YAMAMOTO, Shimada-shi (JP); Satoshi OBATA, Hamamatsu-shi (JP)

(21) Appl. No.: 18/362,093

(22) Filed: Jul. 31, 2023

Related U.S. Application Data
(63) Continuation of application No. PCT/JP2022/002233, filed on Jan. 21, 2022.

(30) Foreign Application Priority Data
Feb. 10, 2021 (JP) 2021-019706

(51) Int. Cl. G09B 15/00; G10H 1/00; G06N 20/00

(52) U.S. Cl. CPC G09B 15/002; G10H 1/0008; G06N 20/00; G10H 2250/311; G10H 2210/066; G10H 2210/061; G10H 2210/091; G10H 2210/571

(57) ABSTRACT

An information processing system (a) acquires user playing data indicative of playing of a piece of music by a user, (b) generates habit data indicative of a playing habit of the user in playing the piece of music on a musical instrument, by inputting the acquired user playing data into at least one first trained model that learns a relationship between (i) player playing training data indicative of playing of a piece of reference music by a player, and (ii) corresponding training habit data indicative of a playing habit of the player in playing the piece of reference music on a musical instrument, the playing habit being indicated by the player playing training data; and (c) identifies a practice phrase based on the generated habit data.

### CROSS REFERENCE TO RELATED APPLICATIONS

This Application is a Continuation Application of PCT Application No. PCT/JP2022/002233 filed on Jan. 21, 2022, and is based on and claims priority from Japanese Patent Application No. 2021-019706 filed on Feb. 10, 2021, the entire contents of each of which are incorporated herein by reference.

### BACKGROUND

### Field of the Invention

This disclosure relates to a technique for assisting users to play electronic musical instruments and other musical instruments.

There have been proposed a variety of techniques for assisting users to play electronic and other musical instruments. For example, Japanese Application Laid-Open Publication JP 2005-055635 discloses calculating statistics (e.g., standard deviation) from differences between parameters of provided music data and parameters of user playing data indicative of musical instrument playing.

In reality, however, provision to a user of such data is not effective in assisting the user to improve their playing ability, since individual user playing habits (e.g., playing mistake patterns) are not taken into account.

### SUMMARY

In view of the circumstances described above, an object of one aspect of this disclosure is to enhance practice of a musical instrument by taking into account an individual user's playing habits.

To achieve the above-stated object, an information processing system according to one aspect of this disclosure includes: at least one memory that stores a program; and at least one processor that executes the program to: acquire user playing data indicative of playing of a piece of music by a user; generate habit data indicative of a playing habit of the user in playing the piece of music on a musical instrument, by inputting the acquired user playing data into at least one first trained model that learns a relationship between (i) player playing training data indicative of playing of a piece of reference music by a player, and (ii) corresponding training habit data indicative of a playing habit of the player in playing the piece of reference music on a musical instrument, the playing habit being indicated by the player playing training data; and identify a practice phrase based on the generated habit data.

An electronic musical instrument according to one aspect of this disclosure includes: a playing device for input operation of a musical instrument by a user; at least one memory that stores a program; and at least one processor that executes the program to: acquire, from the playing device, user playing data indicative of playing of a piece of music by the user; generate habit data indicative of a playing habit of the user in playing the piece of music on the musical instrument, by inputting the acquired user playing data into at least one first trained model that learns a relationship between (i) player playing training data indicative of playing of a piece of reference music by a player, and (ii) corresponding habit training data indicative of a playing habit of the player in playing the piece of reference music on a musical instrument, the playing habit being indicated by the player playing training data; identify a practice phrase based on the generated habit data; and present the identified practice phrase to the user.

A computer-implemented information processing method according to one aspect of this disclosure includes: acquiring user playing data indicative of playing of a piece of music by a user; generating habit data indicative of a playing habit of the user in playing the piece of music on a musical instrument, by inputting the acquired user playing data into at least one first trained model that learns a relationship between (i) player playing training data indicative of playing of a piece of reference music by a player and (ii) corresponding training habit data indicative of a playing habit of the user in playing the piece of music on a musical instrument, the playing habit being indicated by the player playing training data; and identifying a practice phrase based on the generated habit data.

A machine learning system according to one aspect of this disclosure includes: at least one memory that stores a program; and at least one processor that executes the program to: at least one memory that stores a program; and at least one processor that executes the program to: acquire first training data that includes: player playing training data indicative of playing of a piece of reference music by a player; and corresponding habit training data indicative of a playing habit of the player in playing the piece of reference music on a musical instrument, the playing habit being indicated by the player playing training data; and establish, using machine learning with the first training data, at least one first trained model that learns a relationship between the player playing training data and the habit training data.

### BRIEF DESCRIPTION OF THE DRAWINGS

FIG. 1 is a block diagram showing an example of a configuration of a performance system according to a first embodiment.

FIG. 2 is a block diagram showing an example of a configuration of an electronic musical instrument.

FIG. 3 is a block diagram showing an example of a configuration of an information processing system.

FIG. 4 is a block diagram showing an example of a functional configuration of the information processing system.

FIG. 5 is a flowchart showing an example of practice phrase identification procedures.

FIG. 6 is a block diagram showing an example of a configuration of a machine learning system.

FIG. 7 is a block diagram showing an example of a functional configuration of the machine learning system.

FIG. 8 is a block diagram showing an example of a configuration of a computing device used by an instructor.

FIG. 9 is a schematic diagram showing comment data.

FIG. 10 is a flowchart showing preparation procedures.

FIG. 11 is a flowchart showing learning procedures.

FIG. 12 is a block diagram showing an example of a functional configuration of an information processing system according to a second embodiment.

FIG. 13 is a flowchart showing practice phrase identification procedures according to the second embodiment.

FIG. 14 is a block diagram showing an example of a functional configuration of an information processing system according to a third embodiment.

FIG. 15 is a flowchart showing practice phrase identification procedures according to the third embodiment.

FIG. 16 is a functional block diagram showing an example of a machine learning system according to the third embodiment.

FIG. 17 is a flowchart showing learning procedures according to the third embodiment.

FIG. 18 is a block diagram showing an example of a functional configuration of an electronic musical instrument according to a fourth embodiment.

FIG. 19 is a block diagram showing a configuration of a performance system according to a fifth embodiment.

### DESCRIPTION OF THE EMBODIMENTS

### A: First Embodiment

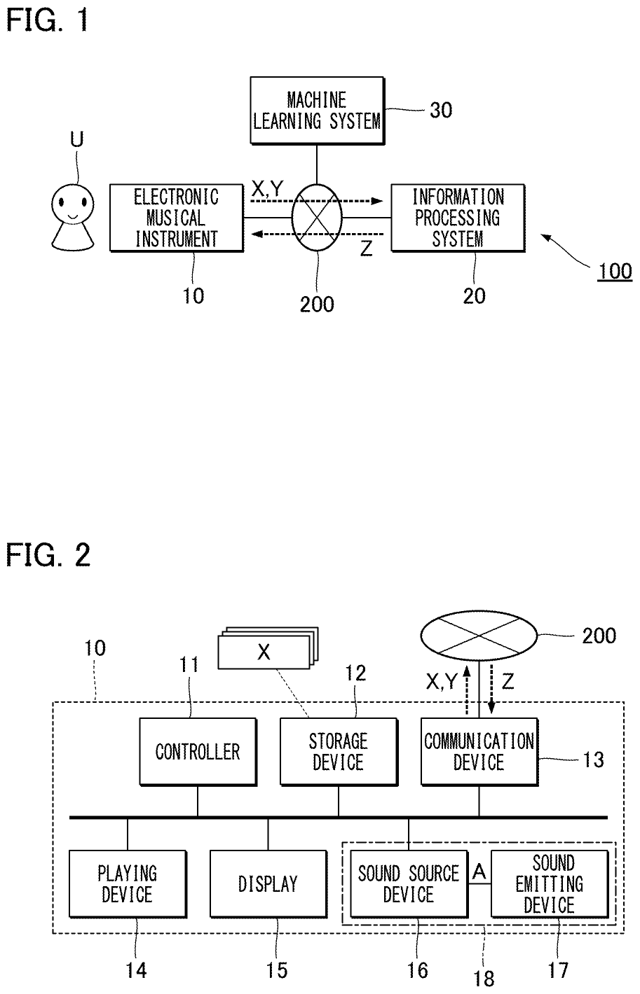

FIG. 1 is a block diagram showing an example of a configuration of a performance system 100 according to the first embodiment. The performance system 100 includes an electronic musical instrument 10, an information processing system 20, and a machine learning system 30. The performance system 100 is a computer system that enables a user U to practice the electronic musical instrument 10. Components of the performance system 100 communicate with each other via a network 200 (e.g., the Internet). Although, the performance system 100 includes more than one electronic musical instrument 10, a single electronic musical instrument is described below for sake of simplicity.

FIG. 2 is a block diagram showing an example of a configuration of the electronic musical instrument 10. The electronic musical instrument 10 is played by the user U. In the first embodiment, the electronic musical instrument 10 is an electronic musical keyboard. The electronic musical instrument 10 is implemented by a computer system and includes a controller 11, a storage device 12, a communication device 13, a playing device 14, a display 15, a sound source device 16, and a sound emitting device 17. The electronic musical instrument 10 may be implemented by not only as a single device, but also as more than one independent device.

The controller 11 comprises one or more processors that control components of the electronic musical instrument 10. Specifically, the controller 11 is constituted of one or more processors, such as a Central Processing Unit (CPU), a Sound Processing Unit (SPU), a Digital Signal Processor (DSP), a Field Programmable Gate Array (FPGA), or an Application Specific Integrated Circuit (ASIC).

The storage device 12 comprises one or memory that stores a program executed by the controller 11 and a variety of types of data used by the controller 11. The storage device 12 may be constituted of a known recording medium, such as a magnetic recording medium or a semiconductor recording medium, or it may be constituted of a combination of more than one type of recording media. Any recording medium, such as a portable recording medium that is attachable to or detachable from the electronic musical instrument 10, or a cloud storage that is accessible by the controller 11 via the network 200, may be used as the storage device 12.

In the first embodiment, the storage device 12 stores a plurality of pieces of music data X, each indicating a different piece of music. The music data X indicates a time series of notes constituting a part of or an entire of piece of music. Specifically, the music data X represents a musical score and indicates each pitch and each duration of a note within the piece of music. The music data X is time series data that conforms to Musical Instrument Digital Interface (MIDI) Standard (MIDI data).

The communication device 13 communicates, via the network 200, with the information processing system 20 either by wire or wirelessly. Alternatively, an independent communication device (e.g., a smart phone and a tablet) may be connected to the electronic musical instrument 10 either by wire or wirelessly.

The display 15 shows images under control of the controller 11. A variety of display panels, such as a liquid crystal display panel and an organic Electroluminescence panel, may be used as the display 15. The display 15 shows a musical score of the piece of music played by the user U based on the music data X.

The playing device 14 includes keys provided in the musical keyboard, with each key corresponding to a different pitch. The playing device 14 receives input operation of the electronic musical instrument 10 by the use. Upon keys being operated by the user U, the electronic musical instrument 10 receives input of user operations via the playing device 14.

The controller 11 generates user playing data Y indicative of playing of a piece of music by the user U. Specifically, the user playing data Y indicates a pitch and duration of each note played by the user U who operates the playing device 14. The user playing data Y is also time series data that conforms to the MIDI Standard (MIDI format data). The communication device 13 transmits the music data X and the user playing data Y to the information processing system 20. The music data X indicates exemplary or standardized optimal playing of the piece of music (i.e., model playing of the piece of music for the user U). In contrast, the user playing data Y indicates actual playing of the electronic musical instrument 10 by the user U. Notes indicated by the music data X correlate with notes indicated by the user playing data Y, but do not fully match each other. More specifically, there is a noticeable difference between the music data X and the user playing data Y at a part of the piece of music where mistakes are made by the user U or at a part where playing by the user U is poor.

The sound source device 16 generates a sound signal A representative of a waveform of the musical sound based on user operation of the playing device 14. Specifically, the sound source device 16 is a MIDI sound source that generates a sound signal A representative of sound of the time series of notes indicated by the user playing data Y. That is, the sound signal A generated by the sound source device 16 represents a musical sound with a pitch that corresponds to a pressed key of the playing device 14. Such a function of the sound source device 16 may be implemented by the controller 11 to execute a program stored in the storage device 12. In this case, the sound source device 16 dedicated to generation of the sound signal A may be omitted.

The sound emitting device 17 emits musical sound represented by the sound signal A. For example, a speaker or a set of headphones is used as the sound emitting device 17. Thus, in the first embodiment, the sound source device 16 and the sound emitting device 17 act as a playback system 18 that plays back musical instrument sound.

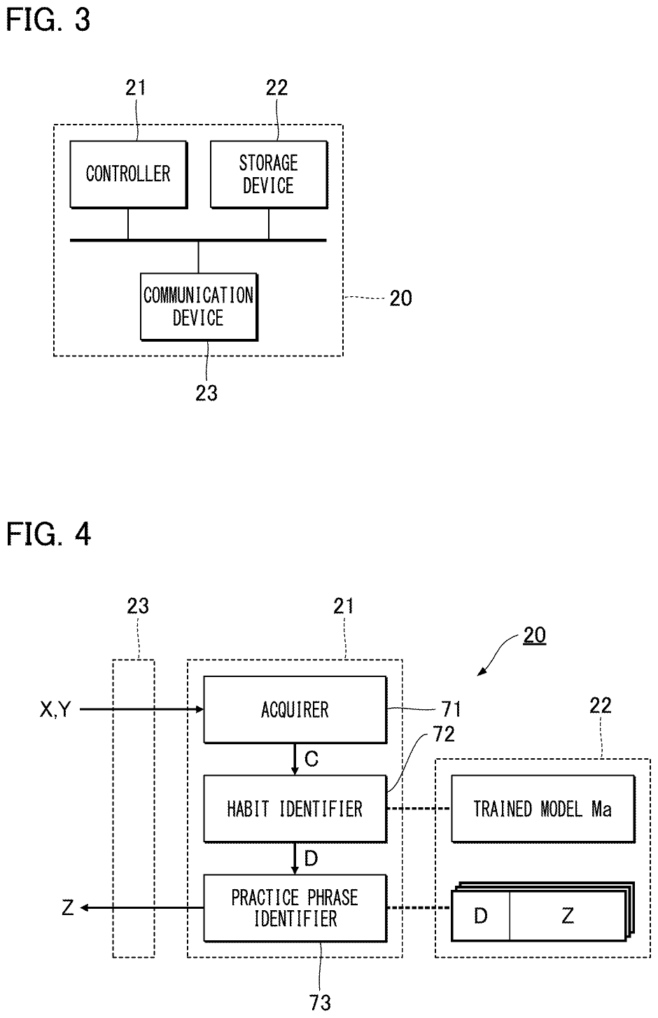

FIG. 3 is a block diagram showing an example of a configuration of the information processing system 20. The information processing system 20 provides the user U with a practice phrase Z, which is a musical phrase appropriate for practice by the user U on the electronic musical instrument 10. The information processing system 20 is implemented by a computer system including a controller 21, a storage device 22, and a communication device 23. The information processing system 20 may be implemented not only as a single device but also as a plurality of independent devices.

The controller 21 comprises one or more processors that control components of the information processing system 20. Specifically, the controller 21 is constituted of one or more processors, such as a CPU, a SPU, a DSP, a FPGA, or an ASIC. The communication device 23 communicates, via the network 200, with the electronic musical instrument 10 and the machine learning system 30 either by wire or wirelessly.

The storage device 22 comprises one or memory that stores a program executed by the controller 21 and a variety of types of data used by the controller 21. The storage device 22 may be constituted of a known recording medium, such as a magnetic recording medium or a semiconductor recording medium, or may be constituted of a combination of more than one type of recording media. Any recording medium, such as a portable recording medium that is attachable to or detachable from the information processing system 20, or a cloud storage that is accessible by the controller 21 via the network 200, may be used as the storage device 22.

FIG. 4 is a block diagram showing an example of a functional configuration of the information processing system 20. Multiple practice phrases Z, each corresponding to different habit data D, are stored in the storage device 22. Specifically, a table is stored in the storage device 22, in which each of the pieces of habit data D is associated with a corresponding practice phrase Z.

The habit data D is freely selected format data and specifies a player's playing habit in playing the electronic musical instrument 10 (hereinafter, simply, “playing habit”). Examples of the playing habit include mistakes in playing, or a playing technique in which the player lacks ability. Specific examples include “shifting a timing of pressing a key,” “pressing a key adjacent to a target key,” “incorrect pitch,” “poor at disjunct motion,” “poor at playing chords,” and “poor at thumb under technique.” From among these playing habits, any one may be specified by the habit data D. Disjunct motion is a pitch difference between two notes where the pitch difference is three steps, for example. Thumb under technique is used to play a note higher or lower than a current note by moving a thumb under other fingers.

A practice phrase Z is a time series of single notes or chords, and is a piece of music comprising a plurality of notes. Specifically, the practice phrase Z is a melody appropriate for the user in practicing the electronic musical instrument 10, and may constitute a part of or an entire piece of practice music. Each practice phrase Z is appropriate for use by the user in improving their playing habit as specified by the habit data D. For example, if the habit data D is “poor at disjunct motion,” a practice phrase Z that includes sufficient disjunct motions is stored in the storage device 22. If the habit data D is “poor at playing chords,” a practice phrase Z that includes a sufficient number of chords is stored in the storage device 22. The practice phrase Z may be in MIDI format that indicates both a pitch and duration of each note.

The controller 21 of the information processing system 20 executes the program stored in the storage device 22 to implement elements that identify the practice phrase Z from the music data X and the user playing data Y (an acquirer 71, a habit identifier 72, and a practice phrase identifier 73).

The acquirer 71 acquires the user playing data Y indicative of playing of a piece of music by the user U. Specifically, the acquirer 71 receives the music data X and the user playing data Y from the electronic musical instrument 10, via the communication device 23. The acquirer 71 generates control data C that includes the music data X and the user playing data Y.

The habit identifier 72 generates habit data D indicative of the user U's playing habit in playing the electronic musical instrument 10 based on the generated control data C. For generation of the habit data D, a trained model Ma is used. The trained model Ma is an example of a “first trained model.”

There is a correlation between (i) a difference between the music data X and the user playing data Y and (ii) the habit data D. More specifically, there is a correlation between the following:

(i) a difference between a musical score of the piece of music played by a player (i.e., model playing for the piece of music), and actual playing of the piece of music played by the player (i.e., actual musical instrument sound), and

(ii) a player's playing habit (habit data D).

When a time point of the onset of a note differs between the music data X and the user playing data Y, a playing habit “shifting a timing of pressing the key” is specified. When an incorrect note, which is close to the correct note indicated by the music data X, is indicated by the user playing data Y, a playing habit “pressing a different key adjacent to the subjected key” is specified. When there is a noticeable difference between the music data X and the user playing data Y at a disjunct motion part, a playing habit “poor at disjunct motion” is specified.

The trained model Ma is a statistical estimation model that has learned such playing habits. Specifically, the trained model Ma learns a relationship between control data C (i.e., a combination of the music data X and the user playing data Y) and habit data D. The habit identifier 72 inputs, into the trained model Ma, the control data C that includes the music data X and the user playing data Y, and the trained model Ma outputs habit data D indicative of the user U's playing habit.

The trained model Ma is a deep neural network (DNN), for example. A type of the deep neural network can be freely selected. For example, a Recursive Neural Network (RNN) or a Convolutional Neural Network (CNN) is used as the trained model Ma. The trained model Ma may comprises a combination of multiple deep neural networks. Additional elements, such as Long Short-Term Memory (LSTM) can be provided in the trained model Ma.

The trained model Ma is implemented by a combination of a program executed by the controller 21 to generate habit data D using control data C, and variables (e.g., weights and biases) used to generate the habit data D. The program for the trained model Ma and the variables are stored in the storage device 22. Numerical values of the variables of the trained model Ma are set in advance by machine learning.

The practice phrase identifier 73, using the habit data D identified by the habit identifier 72, identifies a practice phrase Z based on the user U's playing habit in playing the electronic musical instrument 10. Specifically, multiple practice phrases Z are stored in the storage device 22. The practice phrase identifier 73 searches the storage device 22 for a practice phrase Z based on the identified habit data D. As a result, a practice phrase Z, which is appropriate for use in improving the user U's playing habit based on the habit data D, is identified.

The identified practice phrase Z is transmitted to the electronic musical instrument 10 via the communication device 23. When the electronic musical instrument 10 receives the practice phrase Z from the information processing system 20 via the communication device 13, the controller 11 shows a musical score of the practice phrase Z on the display 15. The user U can play the practice phrase Z while viewing the musical score of the practice phrase shown on the display 15.

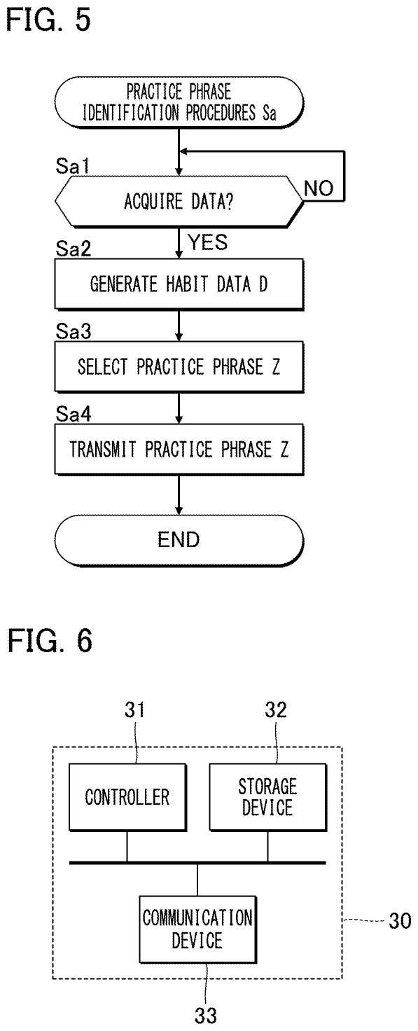

FIG. 5 is a flowchart showing an example of practice phrase identification procedures Sa, which are executed by the controller 21 of the information processing system 20.

When the practice phrase identification procedures Sa are started, the acquirer 71 waits until the communication device 23 receives the music data X and the user playing data Y from the electronic musical instrument 10 (Sa1: NO). When the acquirer 71 acquires the music data X and the user playing data Y (Sa1: YES), the habit identifier 72 inputs control data C, which includes the music data X and the user playing data Y, into the trained model Ma. In response to the input, the trained model Ma outputs habit data D (Sa2). The practice phrase identifier 73 selects a practice phrase Z that corresponds to the habit data D from among the multiple practice phrases Z stored in the storage device 22 (Sa3). The practice phrase identifier 73 transmits the identified practice phrase Z to the electronic musical instrument 10 via the communication device 23 (Sa4).

Thus, in the first embodiment, the user playing data Y is input into the trained model Ma to generate the habit data D indicative of the user U's playing habit, and thereby the practice phrase Z based on the generated habit data D is identified. Playing by the user U of the identified practice phrase Z on the electronic musical instrument 10 enhances practice by the user U.

In the first embodiment, from among the prepared different practice phrases Z, one that corresponds to the user U's playing habit (habit data D) is identified. As a result, a load for identifying the practice phrase Z is reduced.

The trained model Ma is generated by machine learning system 30 shown in FIG. 1. FIG. 6 is a block diagram showing an example of a configuration of the machine learning system 30. The machine learning system 30 includes a controller 31, a storage device 32, and a communication device 33. The machine learning system 30 may be a single device, or a plurality of independent devices.

The controller 31 comprises one or more processors that control components of the machine learning system 30. Specifically, the controller 31 is constituted of one or more processors, such as a CPU, SPU, DSP, FPGA, or ASIC. The communication device 33 communicates, via the network 200, with the information processing system 20 either by wire or wirelessly.

The storage device 32 comprises one or memory that stores a program executed by the controller 31 and a variety of types of data used by the controller 31. The storage device 32 may be constituted of a known recording medium, such as a magnetic recording medium or a semiconductor recording medium, or may be constituted of a combination of more than one type of recording media. Any recording medium, such as a portable recording medium that is attachable to or detachable from the machine learning system 30, or a cloud storage that is accessible by the controller 31 via the network 200, may be used as the storage device 32.

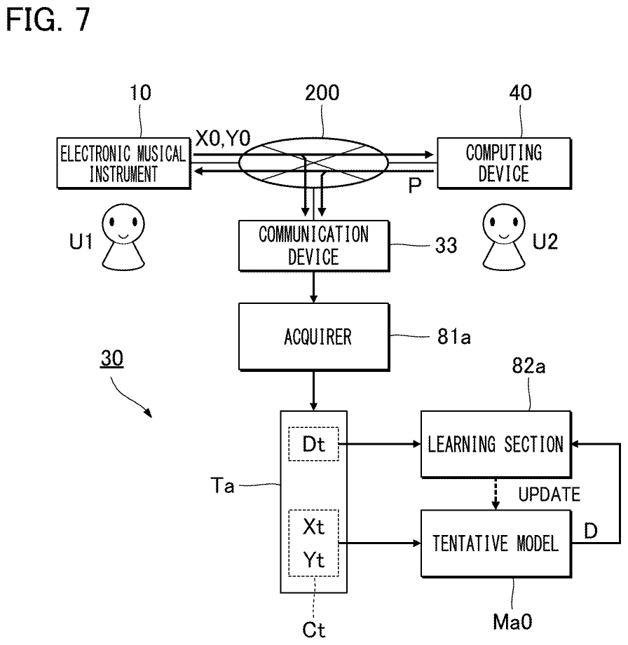

FIG. 7 is a block diagram showing an example of a functional configuration of the machine learning system 30. The controller 31 executes the program stored in the storage device 32 to implement elements (an acquirer 81a and a learning section 82a) that establishes the trained model Ma by machine learning.

The learning section 82a establishes a trained model Ma by supervised machine learning (learning procedures Sc) using pieces of training data Ta. The acquirer 81a acquires the pieces of training data Ta. The acquired pieces of training data Ta are stored in the storage device 32. The training data Ta includes control training data Ct and habit training data Dt. The control training data Ct includes music training data Xt, and player playing data training Yt for. The music training data Xt is an example of “reference music training data,” the player playing training data Yt is an example of “player playing training data,” and the habit training data Dt is an example of “habit training data.” The piece of music indicated by the music training data Xt is an example of “a piece of reference music.” The training data Ta is an example of “first training data.”

As shown in FIG. 7, an instructor U2 instructs a student U1 who practices the electronic musical instrument 10, and evaluates the student U1 using a computing device 40. The training data Ta is generated based on the evaluation made by the instructor U2 and the playing of the electronic musical instrument 10 by the student U1. Examples of the computing device 40 include a smart phone and a tablet. The student U1 and the instructor U2 may, or may not be located remote from each other.

The electronic musical instrument 10 transmits, to the computing device and the machine learning system 30, (i) music data X0 indicative of a piece of music, and (ii) player playing data Y0 indicative of playing of the piece of music played by the student U1. Here, the music data X0 specifies a time series of notes constituting the piece of music, in the same manner to the music data X. The player playing data Y0 indicates a time series of notes from the user operation of the playing device 14.

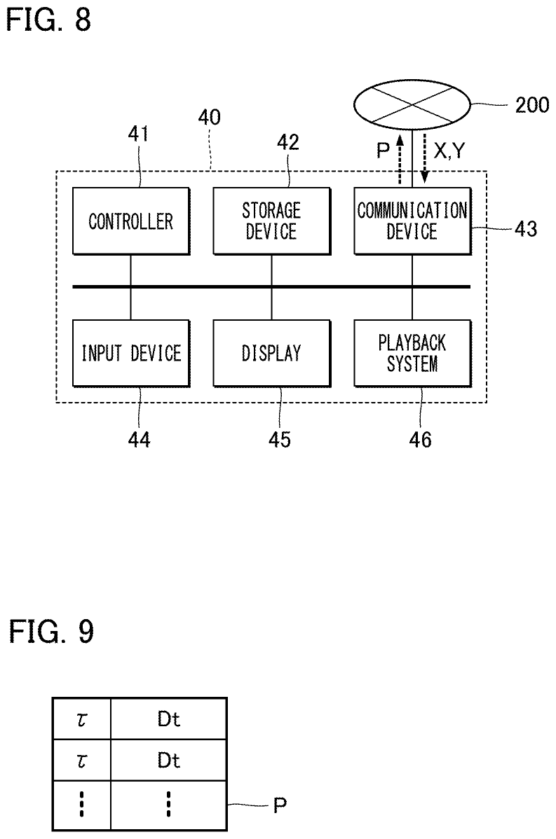

FIG. 8 is a block diagram showing an example of a configuration of the computing device 40. The computing device 40 is used by the instructor U2 to instruct the student U1 who plays the electronic musical instrument 10 and to evaluate the student U1. The computing device 40 includes a controller 41, a storage device 42, a communication device 43, an input device 44, a display 45, and a playback system 46. The computing device 40 may be constituted of more than one independent device.

The controller 41 comprises one or more processors that control components of the computing device 40. Specifically, the controller 41 is constituted of one or more processors, such as a CPU, a SPU, a DSP, a FPGA, or an ASIC.

The storage device 42 comprises one or memory that stores a program executed by the controller 41 and a variety of types of data used by the controller 41. The storage device 42 may be constituted of a known recording medium, such as a magnetic recording medium or a semiconductor recording medium, or may be constituted of a combination of more than one type of recording media. Any recording medium, such as a portable recording medium that is attachable to or detachable from the computing device 40, or a cloud storage that is accessible by the controller 41 via the network 200, may be used as the storage device 42.

The communication device 43 communicates, via the network 200, with the electronic musical instrument 10 and the machine learning system 30 either by wire or wirelessly. The communication device 43 receives the music data X0 and the player playing data Y0 from the electronic musical instrument 10.

The input device 44 receives user instructions from the instructor U2. The input device 44 may be a keypad, or a touch panel. The display 45 shows images under control of the controller 41. Specifically, shown on the display 45 is a time series of notes indicated by the user playing data Y received by the communication device 43. That is, an image related to playing of the electronic musical instrument 10 by the student U1 (e.g., a piano roll, a musical score, etc.) is shown on the display 45. The time series of notes indicated by the music data X as well as the notes of the user playing data Y may be shown on the display 45 at the same time. The playback system 46 plays back sound indicated by the user playing data Y, in the same manner as the playback system 18. As a result, the musical instrument sound played by the student U1 is played back.

The instructor U2 can check playing of the student U1 on the electronic musical instrument 10 while listening to the playback sound from the playback system 46 and viewing the display 45. The instructor U2 inputs, into the input device 44, the student U1's playing habit at a time point (time) at which the playing habit was confirmed within the piece of music. Thus, the student U1's playing habit and the time point at which the playing habit was confirmed are designated. In this embodiment, from among provided options, the student U1's playing habit to be input into the input device 44 is selectable by the instructor U2. Examples of the options include “shifting a timing of pressing the key,” “pressing a key adjacent to the target key,” “incorrect pitch,” “poor at disjunct motion,” “poor at playing chords,” and “poor at playing short notes (e.g., sixteenth notes) at fast tempo.”

The controller 41 generates comment data P based on a user instruction from the instructor U2. FIG. 9 is a schematic diagram of the comment data P. The comment data P includes habit training data Dt and time data τ (tau), for each comment provided by the instructor U2. The habit training data Dt indicates the student U1's playing habit commented on by the instructor U2. The time data τ represents a time point at which the playing habit was confirmed within the piece of music. Thus, the comment data P includes: a playing habit within the piece of music at a time point, and the time point.

The communication device 43 transmits the comment data P generated by the controller 41 to the electronic musical instrument 10 and the machine learning system 30. The communication device 13 of the electronic musical instrument 10 receives the comment data P from the computing device 40. The controller 11 shows comments indicated by the comment data P on the display 15. By viewing the display 15, the student U1 can check comments (the indicated playing habit) made by the instructor U2.

As shown in FIG. 7, the acquirer 81a in the machine learning system 30 receives the music data X0 and the player playing data Y0 from the electronic musical instrument 10 via communication device 33. Further, the acquirer 81a receives the comment data P from the computing device 40. The acquirer 81a generates the training data Ta using the music data X0, the player playing data Y0, and the comment data P. Here, the electronic musical instrument 10 is an example of “a first device,” and the computing device 40 is an example of “a second device.”

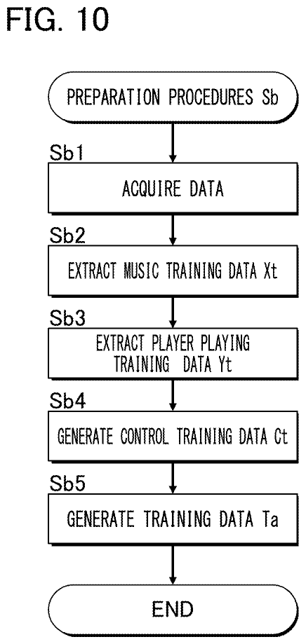

FIG. 10 is a flowchart showing preparation procedures Sb, by which the training data Ta is generated by the acquirer 81a. For example, the preparation procedures Sb are started in response to receipt of data (music data X0, player playing data Y0, and comment data P) by the communication device 33. Upon start of the preparation procedures Sb, the acquirer 81a acquires the music data X0, the player playing data Y0, and the comment data P from the communication device 33 (Sb1).

The music data X0 includes a section (hereinafter, “specific section”), which includes the time point indicated by the time data τ included in the comment data P. The acquirer 81a extracts, from the acquired music data X0, the specific section as the music training data Xt (Sb2). In one example, the specific section is given by a length of a section with its midpoint as a point specified by the time data τ. In addition, the player playing data Y0 includes a specific section, which includes a time point specified by the time data τ included in the comment data P. The acquirer 81a extracts, from the acquired player playing data Y0, the specific section as player playing training data Yt (Sb3). Thus, two specific sections, one for the music data X0 and the other for the player playing data Y0, are extracted. Each specific section includes a time point at which the instructor U2 commented on the student U1's playing habit.

The acquirer 81a generates control training data Ct, which includes the music training data Xt and the player playing training data Yt (Sb4). The acquirer 81a generates training data Ta, in which the control training data Ct is associated with habit training data Dt included in the comment data P (Sb5).

The preparation procedures Sb are repeated for a variety of pieces of music played by a large number of students U1, to generate a large number of pieces of training data Ta. The generated training data Ta includes (i) the music training data Xt and the player playing training data Yt that correspond to the specific section, and (ii) the habit training data Dt representative of the comment at the specific section.

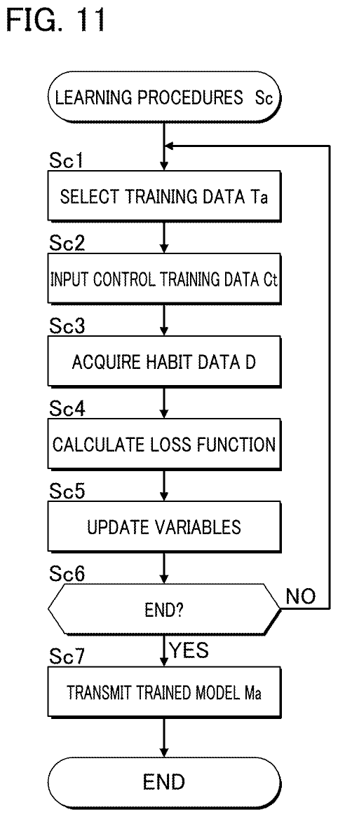

FIG. 11 is a flowchart showing learning procedures Sc, which are executed by the controller 31 of the machine learning system 30 to establish a trained model Ma. The learning procedures Sc are also referred to as a method for generating the trained model Ma by machine learning.

When the learning procedures Sc are started, the learning section 82a selects data from among the pieces of training data Ta stored in the storage device 32 (Sc1). As shown in FIG. 7, the learning section 82a inputs, to an initial or tentative model (hereinafter, “tentative model Ma0”), control training data Ct included in the selected training data Ta (Sc2). When the tentative model Ma0 outputs habit data D in response to the input, the learning section 82a acquires the habit data D from the tentative model Ma0 (Sc3).

The learning section 82a calculates a loss function representative of an error between the habit data D generated by the tentative model Ma0 and the habit training data Dt included in the selected training data Ta (Sc4). The learning section 82a updates variables of the tentative model Ma0 such that the loss function is reduced (ideally, minimized) (Sc5). In one example, an error back propagation method is used to update the variables of the loss function.

The learning section 82a determines whether a termination condition is satisfied (Sc6). The termination condition may be defined by the loss function below a threshold, or may be defined by an amount of change in the loss function below a threshold. When the termination condition is not satisfied (Sc6: NO), the learning section 82a selects new training data Ta that has not yet been selected (Sc1). Thus, until the termination condition is satisfied (Sc6: YES), updating of the variables of the tentative model Ma0 is repeated (Sc2-Sc5). When the termination condition is satisfied (Sc6: YES), the learning section 82a terminates updating (Sc2-Sc5) of the variables defining the tentative model Ma0. The tentative model Ma0 given at the time at which the termination condition is satisfied is determined as the trained model Ma. Variables of the trained model Ma are fixed to numerical values given at the end of the learning procedures Sc.

Under a potential relationship between (i) control training data Ct included in each piece of the training data Ta and (ii) habit training data Dt, the trained model Ma outputs statistically reasonable habit data D for unknown control data C. Thus, the trained model Ma is a statistical training model that has learned a relationship between (i) playing of a piece of music played by a player (control data C) and (ii) the player's playing habit (habit data D).

The learning section 82a transmits the established trained model Ma (specifically, the variables thereof) to the information processing system 20 via the communication device 33 (Sc7). Upon receiving the trained model Ma from the machine learning system 30, the controller 21 of the information processing system 20 stores the received trained model Ma (specifically, the variables thereof) in the storage device 22.

### B: Second Embodiment

The second embodiment will now be described. In the embodiments described below, like reference signs are used for elements that have functions or effects that are the same as those of elements described in the first embodiment, and detailed explanation of such elements is omitted as appropriate.

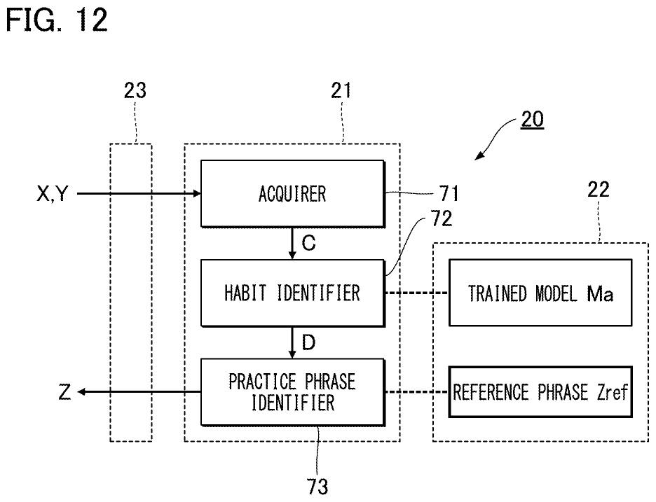

FIG. 12 is a block diagram showing an example of a functional configuration of an information processing system 20 according to the second embodiment. In the first embodiment, multiple practice phrases Z are stored in the storage device 22. In the second embodiment, a single reference phrase Zref is stored in the storage device 22 instead of the practice phrases Z.

The reference phrase Zref is a time series of a piece of music comprising notes, in the same manner as a practice phrase Z according to the first embodiment. Specifically, the reference phrase Zref represents a melody appropriate for practice on the electronic musical instrument 10. The reference phrase Zref may be a part of the practice music or the entire practice music. In the second embodiment, when habit data D is generated by the habit identifier 72, a practice phrase identifier 73 edits the reference phrase Zref based on the generated habit data D, to generate a practice phrase Z. Specifically, the reference phrase Zref includes a part related to the playing habit specified by the habit data D. The practice phrase identifier 73 edits the reference phrase Zref such that a difficulty of the related part of the reference phrase Zref is reduced.

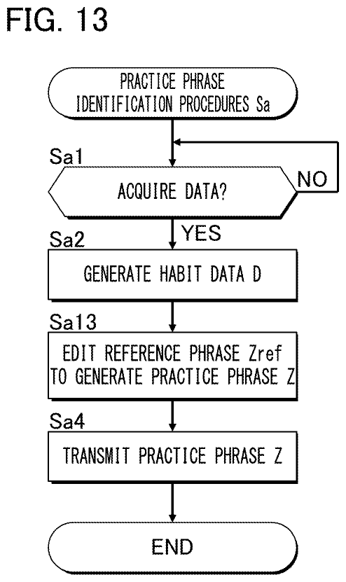

FIG. 13 is a flowchart showing practice phrase identification procedures Sa according to the second embodiment. Step Sa13 shown in FIG. 13 is obtained by replacing step Sa3 shown in FIG. 5 of the first embodiment.

The following two steps are the same as those of the first embodiment: step Sa1 at which the music data X and the user playing data Y are acquired by the acquirer 71, and step Sa2 at which the habit data D is generated by the habit identifier 72. In the second embodiment, the practice phrase identifier 73 edits a reference phrase Zref stored in the storage device 22 based on the habit data D, to generate a practice phrase Z (Sa13). Step Sa4, at which the practice phrase Z is transmitted to the electronic musical instrument 10 from the practice phrase identifier 73, is also the same as that of the first embodiment. Description will now be given of editing of the practice phrase Zref (Sa13).

In one example, for a playing habit (habit data D) “poor at playing chords,” the practice phrase identifier 73 generates a practice phrase Z by changing one or more chords included in the reference phrase Zref. Specifically, when the chords include a chord with notes (component sounds) a number of which exceeds a threshold, the practice phrase identifier 73 omits one or more notes (component sounds) other than the root. Further, when the chords include a chord with a pitch, a difference between a lowest pitch and a highest pitch exceeds a threshold, the practice phrase identifier 73 omits notes (component sounds) including the highest pitch. The omission of these notes (component sounds) reduces the difficulty of playing the chords. Thus, editing the reference phrase Zref includes changing the data.

In one example, for a playing habit (habit data D) “poor at disjunct motion,” the practice phrase identifier 73 omits or changes disjunct motion included in the reference phrase Zref, to generate the practice phrase Z. Specifically, the practice phrase identifier 73 omits a latter one of two notes of the disjunct motion. Further, the practice phrase identifier 73 changes the latter note to a lower pitch note. Thus, editing the reference phrase Zref includes omitting or changing the disjunct motion.

The reference phrase Zref includes designating a playing technique (e.g., a fingering technique), more specifically, a finger number for each note. For a playing habit (habit data D) “thumb under technique,” the practice phrase identifier 73 changes a fingering technique related to the reference phrase Zref, to generate a practice phrase Z. Given that it is difficult for beginners to press a key with a little finger, the practice phrase identifier 73 changes a finger number of the note designated by the reference phrase Zref to another finger number other than the little finger. When the edited practice phrase Z is received by the electronic musical instrument 10, the changed finger number of each note is shown on the display 15 along with the musical score of the practice phrase Z. Thus, editing the reference phrase Zref includes changing the technique for playing the musical instrument.

The second embodiment provides the same effects as those of the first embodiment. Further, in the second embodiment, the practice phrase Z is generated by editing the reference phrase Zref. As a result, it is possible to provide a practice phrase Z appropriate to the level of the user's playing technique.

### C: Third Embodiment

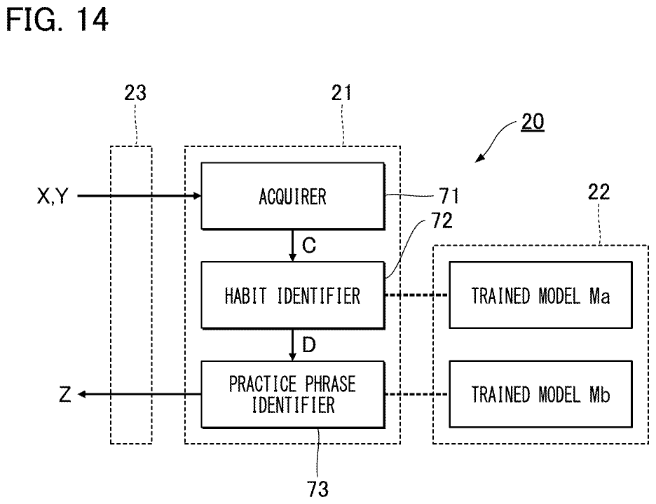

FIG. 14 is a block diagram showing an example of a functional configuration of an information processing system 20 according to the third embodiment. In the first embodiment, the practice phrase identifier 73 selects a practice phrase Z that corresponds to the habit data D from among the multiple practice phrases Z stored in the storage device 22. In the third embodiment, a practice phrase identifier 73 identifies a practice phrase Z based on the habit data D using a trained model Mb. The trained model Mb is an example of a “second trained model.”

As will be apparent from the description of the first embodiment, there is a correlation between the player's playing habit (habit data D) and the practice phrase Z appropriate for the playing habit. The practice phrase Z may be a piece of music appropriate for improving the playing habit indicated by the habit data D that corresponds to the practice phrase Z. The trained model Mb is a statistical estimation model that learns a relationship between the habit data D and the practice phrase Z. In the third embodiment, the practice phrase identifier 73 inputs habit data D generated by the habit identifier 72 into the trained model Mb, to identify a practice phrase Z based on the habit indicated by the habit data D. Specifically, the trained model Mb outputs an indication representative of validity for habit data D that corresponds to a practice phrase Z (i.e., a degree of how appropriate the practice phrase Z is for the user U's playing habit). The practice phrase identifier 73 identifies a practice phrase Z the indication of which is a maximum, from among the practice phrases Z stored in the storage device 22.

The trained model Mb is a DNN, for example. A type of the deep neural network can be freely selected. For example, a RNN or a CNN is used as the trained model Mb. The trained model Mb may comprise a combination of DNNs. Additional elements, such as LSTM can be provided in the trained model Mb.

The trained model Mb is implemented by a combination of the program executed by the controller 21 to predict the practice phrase Z using the habit data D, and variables (e.g., weights and biases) used to predict the practice phrase Z. The program for the trained model Mb and the variables are stored in the storage device 22. Numerical values of the variables of the trained model Mb are set in advance by machine learning.

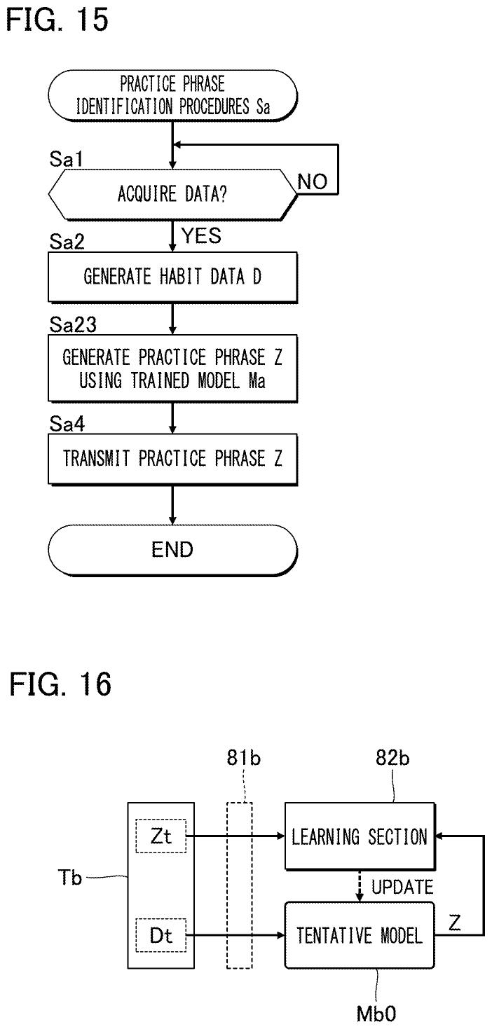

FIG. 15 is a flowchart showing practice phrase identification procedures Sa according to the third embodiment. Step Sa23 shown in FIG. 15 is obtained by replacing step Sa3 shown in FIG. 5 of the first embodiment.

The following two steps are the same as those of the first embodiment: step Sa1 at which the music data X and the user playing data Y are acquired by the acquirer 71, and step Sa2 at which the habit data D is generated by the habit identifier 72. In the third embodiment, the practice phrase identifier 73 inputs the habit data D to the trained model Mb, to identify a practice phrase Z (Sa23). Step Sa4, at which the practice phrase Z is transmitted to the electronic musical instrument 10 from the practice phrase identifier 73, is also the same as that of the first embodiment.

The trained model Mb is generated by the machine learning system 30. FIG. 16 is a functional block diagram showing an example of the machine learning system 30. The controller 31 executes the program stored in the storage device 32 to act as elements for establishing the trained model Mb by machine learning (an acquirer 81b and a learning section 82b).

The learning section 82b establishes a trained model Mb by supervised machine learning (learning procedures Sd) using pieces of training data Tb. The acquirer 81b acquires the pieces of training data Tb. Specifically, the pieces of training data Tb are stored in the storage device 32, and the acquirer 81b acquires them from the storage device 32. Here, the training data Tb is an example of “second training data.”

The training data Tb includes the habit training data Dt and the training practice phrase Zt. The training practice phrase Zt is a piece of music appropriate for improving the playing habit represented by the habit training data Dt included in the training data Tb. A combination of the habit training data Dt and the training practice phrase Zt may be selected by the author of the training data T. The habit training data Dt is an example of “habit training data,” and the training practice phrase Zt is an example of the “training practice phrase.”

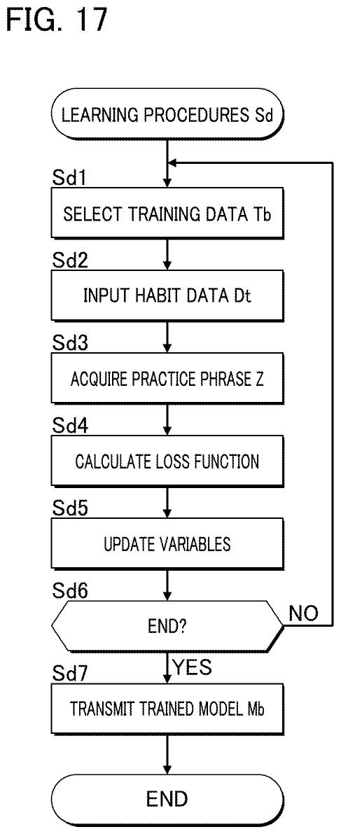

FIG. 17 is a flowchart showing learning procedures Sd, which are executed by the controller 31 to establish the trained model Mb. The learning procedures Sd are also referred to as a method for generating the trained model Mb by machine learning.

When the learning procedures Sd are started, the acquirer 81b selects data from among the pieces of training data Tb stored in the storage device 32 (Sd1). As shown in FIG. 16, the learning section 82b inputs, into an initial or tentative model (hereinafter, “tentative model Mb0”), the habit training data Dt included in the selected training data Tb. When the tentative model Mb0 predicts a practice phrase Z in response to the input, the learning section 82b acquires the predicted practice phrase Z from the tentative model Mb0 (Sd3).

The learning section 82b calculates a loss function representative of an error between the practice phrase Z predicted by the tentative model Mb0 and the training practice phrase Zt included in the selected training data Tb (Sd4). The learning section 82b updates variables of the tentative model Mb0 such that the loss function is reduced (ideally, minimized) (Sd5). In one example, an error back propagation method is used to update the variables of the loss function.

The learning section 82b determines whether a termination condition is satisfied (Sd6). When the termination condition is not satisfied (Sd6: NO), the learning section 82b selects new training data Tb that has not yet been selected (Sd1). Thus, until the termination condition is satisfied (Sd6: YES), updating of the variables of the tentative model Mb0 is repeated (Sd2-Sd5). The tentative model Mb0 given at the time at which the termination condition (Sd6: YES) is satisfied is determined as the trained model Mb.

Under a potential relationship between (i) the habit training data Dt included in each of the pieces of training data Tb and (ii) the training practice phrase Zt, the trained model Mb predicts a statistically reasonable practice phrase Z for unknown habit data D. Thus, the trained model Mb is a statistical prediction model that learns a relationship between the habit data D and the practice phrase Z. In the third embodiment, to identify a practice phrase Z, the practice phrase identifier 73 inputs the habit data D into the trained model Mb that has learned a relationship between the habit training data Dt and the training practice phrase Zt.

The learning section 82b transmits the trained model Mb established by these steps to the information processing system 20 via the communication device 33 (Sd7). Upon receiving the trained model Mb from the machine learning system 30, the controller 21 of the information processing system 20 stores the received trained model Mb in the storage device 22.

The third embodiment provides the same effects as those of the first embodiment. In the third embodiment, the habit data D output by the habit identifier 72 is input into the trained model Mb, and thereby a practice phrase Z is identified. As a result, under a potential relationship between the habit training data Dt and the training practice phrase Zt, a statistically reasonable practice phrase Z can be identified.

### D: Fourth Embodiment

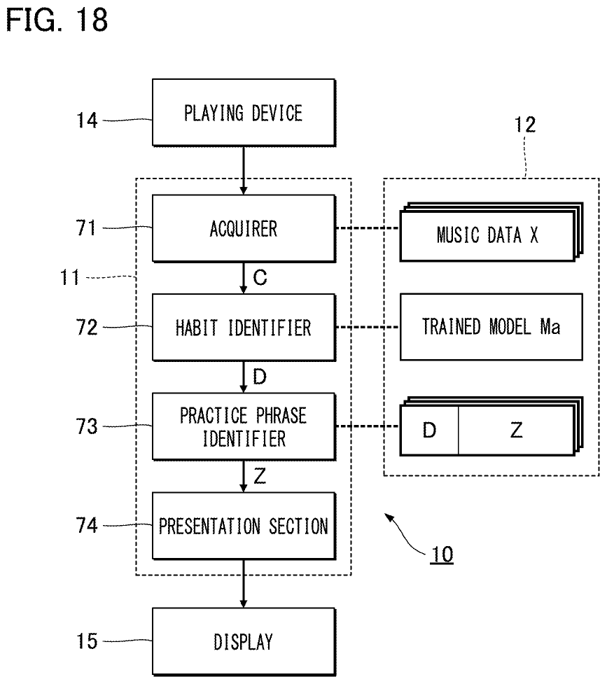

FIG. 18 is a block diagram showing an example of a functional configuration of an electronic musical instrument 10 according to the fourth embodiment. In the foregoing embodiments, the information processing system 20 includes the acquirer 71, the habit identifier 72, and the practice phrase identifier 73. In the fourth embodiment, the electronic musical instrument 10 includes a presentation section 74 in addition to the foregoing elements, that is, the acquirer 71, the habit identifier 72, and the practice phrase identifier 73. These elements are implemented by the controller 11 that executes the program stored in the storage device 12.

The trained model Ma established by the machine learning system 30 is transferred to the electronic musical instrument 10, and is stored in the storage device 12. In addition to the trained model Ma, multiple practice phrases Z and pieces of music data X are stored in the storage device 12. Each practice phrase Z corresponds to different habit data D.

In the same manner as in the first embodiment, the acquirer 71 acquires the music data X representative of the piece of music played by the user U from the storage device 12. Further, the acquirer 71 acquires the user playing data Y representative of playing of the piece of music played by the user U. Specifically, the user playing data Y is generated by the acquirer 71 in response to user operations of the playing device 14. The acquirer 71 generates control data C that includes the music data X and the user playing data Y.

In the same manner as in the first embodiment, the habit identifier 72 generates the habit data D representative of the user U's playing habit based on the generated control data C. Specifically, the habit identifier 72 inputs the control data C that includes the music data X and the user playing data Y into the trained model Ma, to identify the habit data D.

In the same manner as in the first embodiment, the practice phrase identifier 73 identifies the practice phrase Z based on the user U's playing habit, using the habit data D identified by the habit identifier 72. Specifically, multiple practice phrases Z are stored in the storage device 12. The practice phrase identifier 73 searches the storage device 12 for a practice phrase Z that corresponds to the identified habit data D.

The presentation section 74 presents the identified practice phrase Z to the user U. Specifically, the presentation section 74 shows the musical score of the identified practice phrase Z on the display 15. Alternatively, musical sound represented by the practice phrase Z may be played back by the playback system 18.

Thus, the fourth embodiment provides the same effects as those of the first embodiment. The following procedures (i) and (ii), which are executed by the practice phrase identifier 73, are applied to the fourth embodiment including electronic musical instrument 10: (i) editing a practice phrase Z to generate a practice phrase Z in the second embodiment, and (ii) identifying a practice phrase Z using the trained model Mb.

### E: Fifth Embodiment

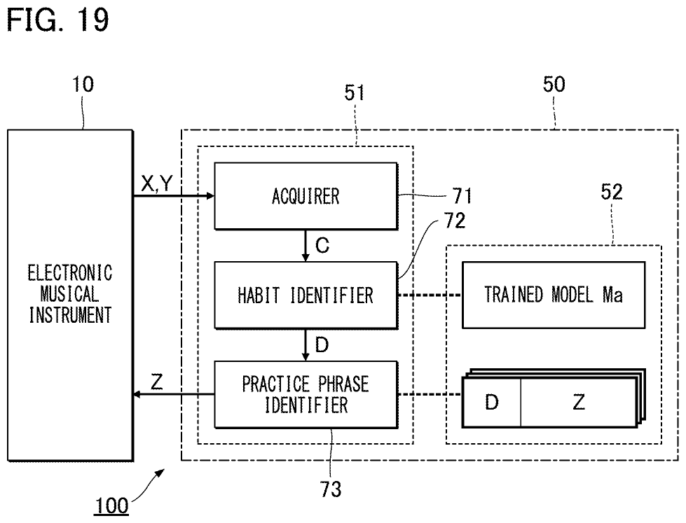

FIG. 19 is a block diagram showing a configuration of a performance system 100 according to the fifth embodiment. The performance system 100 includes an electronic musical instrument 10 and a computing device 50. Examples of the computing device 50 include a smart phone and a tablet. The computing device 50 is connected to the electronic musical instrument 10 either by wire or wirelessly.

The computing device 50 includes a controller 51 and a storage device 52. The controller 51 comprises one or more processors that control components of the computing device 50. Specifically, the controller 51 is constituted of one or more processors, such as a CPU, SPU, DSP, FPGA, or ASIC. The storage device 52 comprises one or memory that stores a program executed by the controller 51 and a variety of types of data used by the controller 51. The storage device 52 may be constituted of a known recording medium, such as a magnetic recording medium or a semiconductor recording medium, or it may be constituted of a combination of more than one type of recording media. Any recording medium, such as a portable recording medium that is attachable to or detachable from the computing device 50, or a cloud storage that is accessible by the controller 51 via the network 200, may be used as the storage device 52.

The controller 51 executes the program stored in the storage device 52 to implement an acquirer 71, a habit identifier 72 and a practice phrase identifier 73. Configuration and operation of each of the elements implemented by the controller 51 (the acquirer 71, the habit identifier 72 and the practice phrase identifier 73) are the same as those of the first through the fourth embodiments. A practice phrase Z identified by the practice phrase identifier 73 is transmitted to the electronic musical instrument 10. The controller 11 of the electronic musical instrument 10 shows a musical score of the identified practice phrase Z on the display 15.

The fifth embodiment provides the same effects as those of the first to fourth embodiments. Examples of an “information processing system” include the information processing system 20 according to the first to third embodiments, the electronic musical instrument 10 according to the fourth embodiment, and the computing device 50 according to the fifth embodiment.

### F: Modifications

Specific modifications applicable to each of the aspects described above are set out below. More than one mode selected from the following descriptions may be combined, as appropriate, as long as such combination does not give rise to any conflict.

(1) In the foregoing embodiments, a single trained model Ma is used to generate habit data D; however multiple trained models Ma may be used. In this case, each trained model Ma corresponds to a different musical instrument. From among the prepared trained models Ma, the habit identifier 72 selects one that corresponds to the musical instrument played by the user U. The habit identifier 72 inputs control data C to the selected trained model Ma, to generate habit data D. For each musical instrument, there is a different relationship between the playing content by the user U (user playing data Y) and a user U's playing habit (habit data D). According to such an example, multiple trained models Ma, each of which corresponds to a different musical instrument, are used. As a result, a user U's playing habit of an actual specific musical instrument can be reflected in habit data D.

(2) In the third embodiment, a single trained model Mb is used to generate a practice phrase Z; however multiple trained models Mb may be used. In this case, multiple trained models Mb, are used, each of which corresponds to a different musical instrument. From among the prepared trained models Mb, the practice phrase identifier 73 selects one that corresponds to the actual musical instrument played by the user. The practice phrase identifier 73 inputs habit data D to the selected trained model Mb, into generate a practice phrase Z.

(3) In the fourth embodiment, from among trained models Ma established by the machine learning system 30, any one may be selected to be transferred to the electronic musical instrument 10. In one example, from among the trained models Ma, one that corresponds to a musical instrument may be selected by the user U, and the selected trained model Ma may be transferred from the machine learning system 30 to the electronic musical instrument 10. Similarly, in the fifth embodiment, the selected trained model Ma may be transferred to the computing device 50. In the third embodiment, from among the established trained models Mb, any one may be selected to be transferred to the information processing system 20.

(4) In the foregoing embodiments, comment data P is generated based on a user instruction from the instructor U2; however the comment data P may be generated by the controller 11 of the electronic musical instrument 10 based on a user instruction from the student U1. Specifically, the controller 11 generates comment data P based on a user instruction from the student U1. The user instruction includes a student U1's playing habit (e.g., playing technique at which the student U1 is poor), and a time point (time) at which the playing habit was confirmed. The controller 11 transmits the generated comment data P to the machine learning system 30 via the communication device 13.

(5-1) In the foregoing embodiment, control data C includes music data X and user playing data Y; however the content of the control data C is not limited to such an example. The control data C may include image data representative of a captured image showing how the user U is playing the electronic musical instrument 10. In one example, the captured image shows movement of both hands of the user U who is playing the musical instrument, and the image may be included in the control data C. Similarly, control training data Ct may include image data representative of a captured image of the player. According to this example, the movement of hands of the user U who is playing the musical instrument is reflected in a practice phrase Z.

(5-2) The control data C need not necessarily include music data X. As long as the control data C includes at least the user playing data Y, the habit identifier 72 can be generated using the trained model Ma.

(6) In the first embodiment, a practice phrase Z appropriate for improving the playing habit of the user U is identified. In the first embodiment, in the same manner as in the second embodiment, the practice phrase identifier 73 can identify a practice phrase Z generated by editing the reference phrase Zref.

(7) The following may be combined with each other: (i) selecting any one of the practice phrases Z based on the habit data D in the first embodiment, and (ii) editing a reference phrase Zref based on the habit data D as in the second embodiment. In one example, from among the practice phrases Z stored in the storage device 22, the practice phrase identifier 73 selects, as a reference phrase Zref, a phrase that corresponds to the habit data D (Sa3). Based on the habit data D, the practice phrase identifier 73 edits the reference phrase Zref to generate a practice phrase Z (Sa13). Thus, the habit data D is used to select the practice phrase Z (Sa3) and to edit the reference phrase Zref (Sa13).

(8) In the second embodiment, the practice phrase identifier 73 edits one reference phrase Zref stored in the storage device 22 to generate the practice phrase Z. However, multiple reference phrases Zref may be used to generate a practice phrase Z. In one example, reference phrases Zref are stored in the storage device 22. The user U who plays the electronic musical instrument 10 may select any one of the stored reference phrases Zref,. In this case, the practice phrase identifier 73 generates the practice phrase Z using the selected reference phrase Zref.

(9) In the foregoing embodiments, the electronic musical instrument 10 is an example of an electronic keyboard instrument; however, this example is not limitative of possible musical instruments. The electronic musical instrument 10 may be an electronic string instrument, such as an electronic guitar. In this case, a sound signal (audio data) representative of oscillation of strings of the electric string instrument, or MIDI format data representative thereof is used as the user playing data Y. Examples of a playing habit of playing the electric string instrument include “not turning down the volume when necessary,” and “causing vibration of non-target strings.” For instruments such as saxophones, trumpets, and other wind instruments, examples of a playing habit reflected in the habit data D include “fluctuating volume” and “inaccurate pitch.” For various percussion instruments, such as drums and configurations thereof, examples of a playing habit reflected in the habit data D include “time shifting in striking a drum” and “poor at continuous short-interval striking.”

(10) In the foregoing embodiments, an example is given of a DNN as a trained model Ma; however the trained model Ma is not limited to such an example. For example, a Hidden Markov Model (HMM), Support Vector Machine (SVM) or other similar statistical estimation model may be used for the trained model Ma. A trained model Ma to which SVM is applied will now be described.

In one example, the trained model Ma comprises more than one SVM that corresponds to a combination of two playing habits (multi-class SVM). Specifically, one SVM is provided for each of a combination in which two playing habits are selected from among different types of playing habits. Each SVM, which corresponds to a combination of two playing habits, determines a hyperplane in a multi-dimensional space by machine learning (learning procedures Sc). The hyperplane represents a boundary that separates data points into two classes in the multi-dimensional space, namely: a class that includes data points of control data C that corresponds to one of the two playing habits, and a class that includes data points of control data C that corresponds to the other of the two playing habits.

A habit identifier 72 inputs control data C into each SVM included in the trained model Ma. Each SVM finds the control data C belongs between the two classes, and selects a playing habit that corresponds to the found class between the two playing habits. The habit identifier 72 generates habit data D representative of a playing habit in which the number of selections by the SVMs is the maximum.

Thus, regardless of the type of the trained model Ma, the habit identifier 72 inputs control data C into the trained model Ma, to generate the habit data D representative of the user U's playing habit. Although the trained model Ma is described, a statistical estimation model, such as HMM or SVM is used to generate a trained model Mb according to the third embodiment.

(11) In the foregoing embodiments, learning procedures Sc are described as one method for supervised machine training using pieces of training data T. However, the trained model Ma may be established by unsupervised machine learning without use of training data T, or by reinforcement learning that maximizes rewards. The unsupervised machine learning may be machine learning using known clustering. Similarly, the trained model Mb according to the third embodiment may be established by unsupervised machine learning or by the reinforcement learning.

(12) In the foregoing embodiments, a trained model Ma is established by the machine learning system 30. However, establishment of the trained model Ma executed by the machine learning system 30 (the acquirer 81a and the learning section 82a) may be implemented by: the information processing system 20 according to the first through the third embodiments, the electronic musical instrument 10 according to the fourth embodiment, or the computing device 50 according to the fifth embodiment. The same conditions are applied to the trained model Mb according to the third embodiment. That is, establishment of the trained model Mb executed by the machine learning system 30 (the acquirer 81b and the learning section 82b) may be implemented by: the information processing system 20 according to the third embodiment, the electronic musical instrument 10 according to the fourth embodiment, or the computing device 50 according to the fifth embodiment.

(13) In the foregoing embodiments, the trained model Ma is used to generate habit data D that corresponds to control data C; however the trained model Ma may be omitted. In this case, a table is provided in which each piece of habit data D is associated with corresponding control data C, and the table is used to generate the habit data D. The table may be stored in the storage device 22 according to the first embodiment, the storage device 12 according to the fourth embodiment, or the storage device 52 according to fifth embodiment. The habit identifier 72 searches the table for the habit data D that corresponds to the control data C generated by the acquirer 71.

(14) In the foregoing embodiments, a trained model Ma is used, which learns a relationship between (i) the control data C that includes the music data X and the user playing data Y, and (ii) the habit data D. However, methods for generating control data C and habit data D are not limited to such an example. Specifically, a reference table (data table) can be provided in which each piece of habit data D is associated with a corresponding piece of control data C, and which is used to generate the habit data D by the habit identifier 72. The reference table is stored in the storage device 22 (the storage device 12 in the fourth embodiment). The habit identifier 72 searches the reference table for control data C that corresponds to a combination of the music data X and the user playing data Y, and acquires the habit data D associated with the control data C located in the reference table.

(15) In the third embodiment, the trained model Mb is used, which learns a relationship between habit data D and a practice phrase Z. However, the method for generating the practice phrase Z from the habit data D is not limited to such an example. Specifically, there is a reference table (data table) in which each of the practice phrases Z is associated with a corresponding piece of habit data D, and the reference table is used to generate a practice phrase Z by the practice phrase identifier 73. Such a reference table is stored in the storage device 22 (the storage device 12 in the fourth embodiment). The practice phrase identifier 73 acquires a practice phrase Z associated with the habit data D from the reference table.

(16) In the foregoing embodiments, the acquirer 71 acquires, from the electronic musical instrument 10, the user playing data Y indicative of playing of a piece of music by the user U. However, the method for acquiring the user playing data Y is not limited to such an example. Specifically, the acquirer 71 need not necessarily acquire the user playing data Y when the user U is playing the electronic musical instrument 10. In one example, playing by the user U is recorded, and the user playing data Y indicative of the recorded playing is acquired by the acquirer 71. According to this example it is not necessary for the acquirer 71 to acquire in real time the user playing data Y.

Further, the acquirer 71 need not necessarily acquire the user playing data Y from the electronic musical instrument 10. Specifically, playing by the user U of the electronic musical instrument 10 may be recorded. The acquirer 71 may receive moving image data indicative of the playing via the communication device 23, and may analyze the moving image data to generate the user playing data Y. Thus, acquisition of the user playing data Y may include receiving the user playing data Y not only from an external device (e.g., the electronic musical instrument 10), but also generating the user playing data Y from moving image data, for example.

(17) In the foregoing embodiments, the acquirer 81a acquires the following: (i) the player playing data Y0 indicative of playing of a piece of music by the student U1, and (ii) comment data P indicative of comments by the instructor U2. However, the method for acquiring training data Ta is not limited to such an example. S Specifically, the acquirer 81a need not necessarily acquire the player playing data Y0 and the comment data P (further, the training data Ta), at a time that the student U1 is playing the musical instrument during a music lesson with the instructor U2. In one example, playing by the student U1 and comments from the instructor U2 are recorded. Player playing data Y0 indicative of the recorded playing, and comment data P indicative of the recorded comment are acquired by the acquirer 81a. According to this example, acquisition by the acquirer 81a of player playing data Y0 of the student U1 and comment data P of the instructor U2 is not confined to real time.

The acquirer 81a need not necessarily acquire the player playing data Y0 from the electronic musical instrument 10. Specifically, playing by the student U1 of the musical instrument may be recorded. The acquirer 81a may receive moving image data indicative of the playing via the communication device 23, and may analyze the moving image data to generate player playing data Y0. Thus, acquisition of the player playing data Y0 may include receiving the user playing data Y not only from an external device (e.g., the electronic musical instrument 10), but also generating the player playing data Y0 from moving image data, for example.

Similarly, the acquirer 81a need not necessarily acquire the comment data P from the electronic musical instrument 10. Specifically, the instructor U2 may instruct the student U1 via recording. The acquirer 81a may receive moving image data indicative of the instruction via the communication device 23, and analyze the moving image data to generate the comment data P. Thus, acquisition of the comment data P includes not only receipt from an external device (e.g., the computing device 40), but also generation from moving image data, for example.

(18) In the foregoing embodiments, the player playing data Y0 is transmitted from the electronic musical instrument 10 to the machine learning system 30. However, the player playing training data Yt may be transmitted from the electronic musical instrument 10 to the machine learning system 30. In this case, the controller 11 of the electronic musical instrument 10 receives the comment data P from the computing device 40. Player playing data Y0 to be transmitted includes a specific section, which includes a time point specified by the time data τ included in the comment data P. The controller 11 transmits the specific section as player playing training data Yt to the machine learning system 30. The acquirer 81a receives the player playing training data Yt from the electronic musical instrument 10. According to this example, the machine learning system 30 need not necessarily acquire the time data τ from the computing device 40. In this case, the time data τ may be omitted from the comment data P.

Although the player playing training data Yt is described, music training data Xt may be transmitted from the electronic musical instrument 10 to the machine learning system 30. In this case, music data X0 to be transmitted includes a specific section, which includes a time point specified by the time data τ included in the comment data P The controller 11 of the electronic musical instrument 10 transmits the specific section as music training data Xt to the machine learning system 30. The acquirer 81a receives the music training data Xt transmitted from the electronic musical instrument 10.

(19) The functions of the acquirer 71, the habit identifier 72 and the practice phrase identifier 73 are implemented by cooperation of one or more processors, which comprises the controller, and a program stored in the storage device. The program may be provided by being pre-recorded on a computer-readable recording medium, and may be installed in a computer. For example, the computer-readable recording medium may be a non-transitory recording medium, examples of which include an optical recording medium (optical disk), such as a CD-ROM. The computer-readable recording medium may be a known recording medium, such as a semiconductor recording medium, or a magnetic recording medium. The non-transitory recording medium includes any recording medium excluding a transitory propagating signal A volatile recording medium is not excluded. When programs are distributed by a distribution device via the network 200, a storage device included in the distribution device corresponds to a non-transient recording medium described above.

### G: Appendices

The following configurations are derivable from the foregoing embodiments.

An information processing system according to one aspect (Aspect 1) of this disclosure includes: at least one memory that stores a program; and at least one processor that executes the program to: (a) acquire user playing data indicative of playing of a piece of music by a user; (b) generate habit data indicative of a playing habit of the user in playing the piece of music on a musical instrument, by inputting the acquired user playing data into at least one first trained model that learns a relationship between (i) player playing training data indicative of playing of a piece of reference music by a player, and (ii) corresponding training habit data indicative of a playing habit of the player in playing the piece of reference music on a musical instrument, the playing habit being indicated by the player playing training data; and (c) identify a practice phrase based on the generated habit data.

According to this aspect, user performance data indicative of playing of a piece of music by a user is input into the trained model, and thereby habit data indicative of a user's playing habit is generated to identify a practice phrase based on the generated habit data. As a result, playing of the practice phrase enhances practice of a musical instrument by the user.

The user playing data is in a freely selected format and is indicative of playing by the user. Examples of the user playing data include MIDI format data (a time series of notes played by the user), and sound data indicative of an instrument sound played by the user. In addition, moving image data indicative of how the user plays the musical instrument may be included in the user playing data.

The habit data is in a freely selected format and is indicative of a user's habit in playing the musical instrument. In one example, the playing habit in playing the musical instrument constitutes mistakes in playing, or a poor playing technique. In one example, the habit data specifies a mistake made in playing or a playing habit from among a variety of playing habits.

The practice phrase is a series of notes (melody) that the user plays to practice the musical instrument. The phrase “practice phrase that depends on the user's playing habit” refers to a series of notes appropriate for use by the user to overcome a mistake in playing, or to improve a playing technique at which the user is poor. The practice phrase may be an entire of a piece of music, or may be a part thereof.

In an example (Aspect 2) according to Aspect 1, the at least one first trained model learns a relationship between (i) control training data that includes: (i-1) the player playing training data; and (i-2) reference music training data indicative of a musical score of the piece of reference music; and (ii) the corresponding habit training data. The at least one processor executes the program to generate the habit data by inputting, into the at least one first trained model, control data that includes: the user playing data; and music data indicative of a musical score of the piece of music.

According to this aspect, the control data includes the user playing data in addition to the music data. As a result, appropriate habit data indicative of a relationship between the two (e.g., same or different) can be generated.

In an example (Aspect 3) according to Aspect 1 or 2, the information processing system further includes a plurality of practice phrases, each practice phrase of the plurality of practice phrases corresponding to a different playing habit of a different player in playing the musical instrument. The at least one processor further executes the program to select a practice phrase that corresponds to the generated habit data from among the plurality of practice phrases.

According to this aspect, a practice phrase that corresponds to the habit data is selected from among the practice phrases. As a result, a load in identifying a practice phrase is reduced.

In an example (Aspect 4) according to Aspect 1 or 2, the at least one processor further executes the program to generate the practice phrase by editing a reference phrase based on the generated habit data.

According to this aspect, the practice phrase is generated by editing the reference phrase. As a result, it is possible to provide a practice phrase appropriate to the user's level of playing technique.

The phrase “editing the reference phrase” means changing the reference phrase such that difficulty of playing changes dependent on the habit data. Examples of “editing the reference phrase” include simplifying chords in the reference phrase (e.g., omission of component sounds of each chord), omitting disjunct motion (a part of playing two consecutive notes with a large pitch difference), and simplifying fingering during playing.

In an example (Aspect 5) according to Aspect 4, the reference phrase includes a time series of chords, and the editing of the reference phrase includes changing the time series of chords.

In another example (Aspect 6) according to Aspect 4, the reference phrase includes a disjunct motion in which a pitch difference exceeds a threshold, and the editing of the reference phrase includes omitting or changing the disjunct motion.

In a yet another example (Aspect 7) according to Aspect 4, the reference phrase includes designating a playing technique for a musical instrument, and the editing of the reference phrase includes changing the playing technique.

The playing technique refers to a method for playing a musical instrument. Examples of the playing technique include fingering when playing a musical keyboard or a stringed musical instrument, hammering when playing a string musical instrument (e.g., a guitar or a bass), coupling, and cutting.

In an example (Aspect 8) according to any one of Aspects 1 to 4, the information processing system further includes at least one second trained model that learns a relationship between (i) the habit training data, and (ii) corresponding training practice phrase based on the playing habit indicated by the habit training data. The at least one processor further executes the program to identify the practice phrase by inputting the habit data into the at least one second trained model.

According to this aspect, the habit data is input into a second trained model, to identify practice phrase. As a result, under a potential relationship between the habit training data and the training practice phrase, a statistically reasonable practice phrase can be identified.

In an example (Aspect 9) according to Aspect 8, the at least one second trained model comprises a plurality of second trained models, each second trained model of the plurality of second trained models corresponding to a different musical instrument. The at least one processor further executes the program to identify the practice phrase by using any one of the plurality of second trained models.

According to this aspect, a practice phrase suitable for a specific musical instrument played by the user is identified, as compared with a case where a single second trained model is used to identify a practice phrase.

In an example (Aspect 10) according to any one of Aspects 1 to 9, the at least one first trained model comprises a plurality of first trained models, each first trained model of the plurality of first trained models corresponding to a different musical instrument. The at least one processor further executes the program to generate the habit data by using any one of a first trained model from among the plurality of first trained models.

According to this aspect, first learned models, each of which corresponds to a different musical instrument, are used to generate habit data. As a result, habit data appropriate for a specific musical instrument played by the user is identified, as compared to a case where a single first learned model is used to generate habit data.

An electronic musical instrument according to one aspect (Aspect 11) of this disclosure includes: (a) a playing device for input operation of a musical instrument by a user; (b) at least one memory that stores a program; and (c) at least one processor that executes the program to: (i) acquire, from the playing device, user playing data indicative of playing of a piece of music by the user; (ii) generate habit data indicative of a playing habit of the user in playing the piece of music on the musical instrument, by inputting the acquired user playing data into at least one first trained model that learns a relationship between (ii-1) player playing training data indicative of playing of a piece of reference music by a player, and (ii-2) corresponding habit training data indicative of a playing habit of the player in playing the piece of reference music on a musical instrument, the playing habit being indicated by the player playing training data; (d) identify a practice phrase based on the generated habit data; and (e) present the identified practice phrase to the user.

A practice phrase is presented to the user either as visual material or as auditory material. A musical score of a practice phrase may be shown on a display. Alternatively, a musical instrument sound represented by the practice phrase may be emitted.

A computer-implemented information processing method according to one aspect (Aspect 12) of this disclosure includes: (a) acquiring user playing data indicative of playing of a piece of music by a user; (b) generating habit data indicative of a playing habit of the user in playing the piece of music on a musical instrument, by inputting the acquired user playing data into at least one first trained model that learns a relationship between (i) player playing training data indicative of playing of a piece of reference music by a player, and (ii) corresponding training habit data indicative of a playing habit of the user in playing the piece of music on a musical instrument, the playing habit being indicated by the player playing training data; and (c) identifying a practice phrase based on the generated habit data.

In an example (Aspect 13) according to Aspect 12, the information processing method further includes providing a plurality of practice phrases, each practice phrase of the plurality of practice phrases corresponding to a different playing habit of a different player in playing the musical instrument. The practice phrase is identified by selecting a practice phrase that corresponds to the generated habit data, from among the plurality of practice phrases.

In another example (Aspect 14) according to Aspect 12, the practice phrase is identified by editing a reference phrase based on the generated habit data, to generate the practice phrase.

In a yet another example (Aspect 15) according to Aspect 12, at least one second trained model that learns a relationship between (i) the habit training data, and (ii) a corresponding training practice phrase based on the playing habit indicated by the habit training data. The practice phrase is identified by inputting the habit data into the at least one second trained model.

A machine learning system according to one aspect (Aspect 16) of this disclosure includes: at least one memory that stores a program; and at least one processor that executes the program to: (a) acquire first training data that includes: (i) player playing training data indicative of playing of a piece of reference music by a player, and (ii) corresponding habit training data indicative of a playing habit of the player in playing the piece of reference music on a musical instrument, the playing habit being indicated by the player playing training data; and (b) establish, using machine learning with the first training data, at least one first trained model that learns a relationship between the player playing training data and the habit training data.

According to this aspect, under a potential relationship between the user playing training data and the habit training data, statistically reasonable habit data for the practice playing data can be generated by the first trained model.

In an example (Aspect 17) according to Aspect 16, the acquiring of the first training data includes: (a) acquiring player playing data indicative of playing of the piece of reference music by the player; (b) acquiring comment data indicating (i) a playing habit of the player in playing the musical instrument at a time point within the piece of reference music, and (ii) the time point; and (c) generating the first training data that includes: (i) the player playing training data, and (ii) the corresponding habit training data. The player playing data includes a section that includes the time point indicated by the comment data. The player playing training data indicates the playing of the piece of reference music within the section of the player playing data. The corresponding habit training data indicates the playing habit indicated by the comment data.

According to this aspect, the source of the user playing data (e.g., a first apparatus) is no longer needed to extract a section that corresponds to the time point indicated by the comment data on the playing by the user.

In an example (Aspect 18) according to Aspect 17, the at least one processor further executes the program to: acquire the player playing data from a first apparatus; and acquire the comment data from a second apparatus.

According to this aspect, data used for machine learning can be prepared by using the user playing data and the comment data acquired from the first and second apparatus, which are located remotely from each other. The first apparatus may be a terminal apparatus used by the student to practice the musical instrument. The second apparatus may be a terminal apparatus used by the instructor to instruct the student and evaluate the playing by the student.

In an example (Aspect 19) according to any one of Aspects 16 to 18, the first trained model learns a relationship between (i) control training data that includes the player playing training data; and reference music training data indicative of a musical score of the piece of reference music, and (ii) the corresponding habit training data.

According to this aspect, the control training data includes the player playing training data in addition to the music training data. As a result, a first trained model, which generates appropriate habit data reflecting the relationship between the two (e.g., identical or not), can be generated.

In an example (Aspect 20) according to any one of Aspects 16 to 19, the at least one processor further executes the program to: (a) acquire a plurality of pieces of second training data, each piece of second training data of the plurality of pieces of second training data including (i) the habit training data, and (ii) corresponding training practice phrase based on the playing habit indicated by the habit training data; and (b) establish, using the plurality of pieces of second training data with machine learning, a second trained model that learns a relationship between (i) the habit training data of each piece of second training data, and (ii) the corresponding training practice phrase of each piece of second training data.

A computer-implemented machine learning method according to one aspect (Aspect 21) of the present disclosure includes: (a) acquiring player playing data indicative of playing of a piece of reference music by a player; (b) acquiring comment data indicating: (i) a playing habit of the player in playing a musical instrument at a time point within the piece of reference music; and (ii) the time; and (c) establishing a first trained model that learns a relationship between (i) player playing training data and habit training data, using machine learning with first training data. The player playing data includes a section that includes a time point indicated by the comment data. The first training data includes the player playing training data indicative of playing of the piece of reference music within the section of the player playing data, and the habit training data indicative of the playing habit indicated by the comment data.

### DESCRIPTION OF REFERENCES SIGNS

100: performance system, 10: electronic musical instrument, 11, 21, 31, 41, 51: controller, 12, 22, 32, 42, 52: storage device, 13, 23, 33, 43, 53: communication device, 14: playing device, 15, 45: display, 16: sound source device, 17: sound emitting device, 18, 46: playback system, 20: information processing system, 30: machine learning system, 40: computing device, 44: input device, 50: computing device, 71: acquirer, 72: habit identifier, 73: practice phrase identifier, 74: presentation section, 81a, 81b: acquirer, and 82a, 82b: learning section.

What is claimed is:

1. An information processing system comprising:
at least one memory that stores a program; and
at least one processor that executes the program to:
acquire user playing data indicative of playing of a piece of music by a user;
generate habit data indicative of a playing habit of the user in playing the piece of music on a musical instrument, by inputting the acquired user playing data into at least one first trained model that learns a relationship between:
player playing training data indicative of playing of a piece of reference music by a player; and
corresponding training habit data indicative of a playing habit of the player in playing the piece of reference music on a musical instrument, the playing habit being indicated by the player playing training data; and
identify a practice phrase based on the generated habit data.

2. The information processing system according to claim 1, wherein:
the at least one first trained model Teams a relationship between:
(i) control training data that includes:
the player playing training data; and
reference music training data indicative of a musical score of the piece of reference music; and
(ii) the corresponding habit training data, and
the at least one processor executes the program to generate the habit data by inputting, into the at least one first trained model, control data that includes:
the user playing data; and
music data indicative of a musical score of the piece of music.

3. The information processing system according to claim 1, further comprising a plurality of practice phrases, each practice phrase of the plurality of practice phrases corresponding to a different playing habit of a different player in playing the musical instrument,
wherein the at least one processor further executes the program to select a practice phrase that corresponds to the generated habit data from among the plurality of practice phrases.

4. The information processing system according to claim 1, wherein the at least one processor further executes the program to generate the practice phrase by editing a reference phrase based on the generated habit data.

5. The information processing system according to claim 4, wherein:
the reference phrase includes a time series of chords, and
the editing of the reference phrase includes changing the time series of chords.

6. The information processing system according to claim 4, wherein:
the reference phrase includes a disjunct motion in which a pitch difference exceeds a threshold, and
the editing of the reference phrase includes omitting or changing the disjunct motion.

7. The information processing system according to claim 4, wherein:
the reference phrase includes designating a playing technique for a musical instrument, and
the editing of the reference phrase includes changing the playing technique.

8. The information processing system according to claim 1, further comprising at least one second trained model that learns a relationship between:
the habit training data; and
corresponding training practice phrase based on the playing habit indicated by the habit training data,
wherein the at least one processor further executes the program to identify the practice phrase by inputting the habit data into the at least one second trained model.

9. The information processing system according to claim 8, wherein:
the at least one second trained model comprises a plurality of second trained models, each second trained model of the plurality of second trained models corresponding to a different musical instrument, and
the at least one processor further executes the program to identify the practice phrase by using any one of the plurality of second trained models.

10. The information processing system according to claim 1, wherein:
the at least one first trained model comprises a plurality of first trained models, each first trained model of the plurality of first trained models corresponding to a different musical instrument, and
the at least one processor further executes the program to generate the habit data by using any one of a first trained model from among the plurality of first trained models.

11. An electronic musical instrument comprising:
a playing device for input operation of a musical instrument by a user;
at least one memory that stores a program; and
at least one processor that executes the program to:
acquire, from the playing device, user playing data indicative of playing of a piece of music by the user;
generate habit data indicative of a playing habit of the user in playing the piece of music on the musical instrument, by inputting the acquired user playing data into at least one first trained model that learns a relationship between:
player playing training data indicative of playing of a piece of reference music by a player; and
corresponding habit training data indicative of a playing habit of the player in playing the piece of reference music on a musical instrument, the playing habit being indicated by the player playing training data;
identify a practice phrase based on the generated habit data; and
present the identified practice phrase to the user.

12. A computer-implemented information processing method comprising:
acquiring user playing data indicative of playing of a piece of music by a user;
generating habit data indicative of a playing habit of the user in playing the piece of music on a musical instrument, by inputting the acquired user playing data into at least one first trained model that learns a relationship between:
player playing training data indicative of playing of a piece of reference music by a player; and
corresponding training habit data indicative of a playing habit of the user in playing the piece of music on a musical instrument, the playing habit being indicated by the player playing training data; and
identifying a practice phrase based on the generated habit data.

13. The computer-implemented information processing method according to claim 12, further comprising providing a plurality of practice phrases, each practice phrase of the plurality of practice phrases corresponding to a different playing habit of a different player in playing the musical instrument,
wherein the practice phrase is identified by selecting a practice phrase that corresponds to the generated habit data, from among the plurality of practice phrases.

14. The computer-implemented information processing method according to claim 12, wherein the practice phrase is identified by editing a reference phrase based on the generated habit data, to generate the practice phrase.

15. The computer-implemented information processing method according to claim 12, further comprising at least one second trained model that learns a relationship between:
the habit training data; and
a corresponding training practice phrase based on the playing habit indicated by the habit training data,
wherein the practice phrase is identified by inputting the habit data into the at least one second trained model.

16. A machine learning system comprising:
at least one memory that stores a program; and
at least one processor that executes the program to:
acquire first training data that includes:
player playing training data indicative of playing of a piece of reference music by a player; and
corresponding habit training data indicative of a playing habit of the player in playing the piece of reference music on a musical instrument, the playing habit being indicated by the player playing training data; and
establish, using machine learning with the first training data, at least one first trained model that learns a relationship between the player playing training data and the habit training data.

17. The machine learning system according to claim 16, wherein:
the acquiring of the first training data includes:
acquiring player playing data indicative of playing of the piece of reference music by the player;
acquiring comment data indicating:
a playing habit of the player in playing the musical instrument at a time point within the piece of reference music; and
the time point; and
generating the first training data that includes:
the player playing training data; and
the corresponding habit training data,
the player playing data includes a section that includes the time point indicated by the comment data,
the player playing training data indicates the playing of the piece of reference music within the section of the player playing data, and
the corresponding habit training data indicates the playing habit indicated by the comment data.

18. The machine learning system according to claim 17, wherein:
the at least one processor further executes the program to:
acquire the player playing data from a first apparatus; and
acquire the comment data from a second apparatus.

19. The machine learning system according to claim 16, wherein the first trained model learns a relationship between:
(i) control training data that includes:
the player playing training data; and
reference music training data indicative of a musical score of the piece of reference music; and
(ii) the corresponding habit training data.

20. The machine learning system according to claim 16, wherein the at least one processor further executes the program to:
acquire a plurality of pieces of second training data, each piece of second training data of the plurality of pieces of second training data including:
the habit training data; and
corresponding training practice phrase based on the playing habit indicated by the habit training data; and
establish, using the plurality of pieces of second training data with machine learning, a second trained model that learns a relationship between:
the habit training data of each piece of second training data; and
the corresponding training practice phrase of each piece of second training data.
